(19) United States
(12) Patent Application Publication
(10) Pub. No.: US 2022/0100178 A1
(43) Pub. Date: Mar. 31, 2022

(54) METHOD FOR DETERMINING PROCESS SEQUENCES

(71) Applicants: Gerd Hübscher, Wien (AT); Georg Puchberger, Wien (AT)

(72) Inventors: Gerd Hübscher, Wien (AT); Dagmar Auer, Hagenberg (AT); Verena Geist, Steyr-Gleink (AT); Josef Küng, Hagenberg (AT); Stefan Nadschläger, Walding (AT)

(21) Appl. No.: 17/275,427

(22) PCT Filed: Sep. 11, 2019
(86) PCT No.: PCT/AT2019/060299

§ 371 Date: Dec. 15, 2021

(30) Foreign Application Priority Data
Sep. 11, 2018 (AT) A50777/2018

(51) Int. Cl. G05B 19/418

(52) U.S. Cl. CPC G05B 19/41835; G05B 2219/35263

(57) ABSTRACT

A method for determining process sequences from individual process data (21), which occur repeatedly in successive process steps, have a variable value (22) and a constant reference content (23), is described, wherein, for successive process steps, the process data (21) are assigned to unique existing object data records with value (28) or object data records with value (28) that are to be newly created using their detected value (22) and using their reference content (23). In order to record process data with high integrity and to be able to determine process sequences, it is proposed that the object data records with value (28) are linked to object data records without value (30, 33) via object relation data records (29, 32) according to their reference content (23), wherein the existing object data records (28) are linked to a process step data record assigned to the respective process step via a process input data record and the newly created object data records (30, 33) and object relation data records (29, 32) are linked to the process step data record via a process output data record.

### TECHNICAL FIELD

The invention relates to a method and a device for determining process sequences from individual process data, which occur repeatedly in successive process steps, have a variable value and a constant reference content, wherein, for successive process steps, the process data are assigned to unique existing object data records with value or object data records with value that are to be newly created using their detected value and using their reference content.

### STATE OF THE ART

In order to be able to monitor and control running processes in industrial plants or other information processing systems, methods are known in which process data of successive process steps are acquired and stored. These process data usually contain a variable value, such as a number, a text, and a reference content that is constant in the context of the process. The reference content may, for example, be the temperature of a specific system component, order data or a serial number of the processed product or its dimensions, which are stored according to a predefined file plan. Particularly in the case of processes with a very large number of different process options, which alternately comprise fully automated, partially automated and manual process steps carried out by a user, this results in the disadvantage that the actual process sequence cannot be traced or can only be traced with great effort, even though individual process data occur and/or are required in several successive process steps. This is particularly the case if the process data contain process-related information in the form of data that are not machine-readable, such as order information, instructions, or notes from users, because the information content of these data can only be inadequately acquired and evaluated by machine.

It has therefore already been suggested to predefine several different process sequences in order to be able to assign the accumulating process data to the individual predefined process sequences. However, with many different process sequences, such a configuration is extremely time-consuming or not possible with process steps or process sequences that are not known in advance, which leads to process data either not being acquired completely or being acquired several times, which jeopardizes the integrity, in particular the consistency and temporal correctness of the processed process data. For example, it may be unclear when a process datum actually occurred for the first time and when it is merely referred to. It is therefore not or only incompletely possible to determine process sequences in such systems.

### DESCRIPTION OF THE INVENTION

The invention is thus based on the object of designing a method and a device of the type described at the beginning in such a way that accumulating process data and actual process sequences of safety critical processes with varied sequence variants and a priori unknown process sequences can be determined between fully automated, partially automated and manual process steps carried out by a user with high integrity of the recorded process data and rapid processing speed and can be used for control and regulation.

For that purpose, the object data records with value are linked via object relation data records according to their reference content to object data records without value, wherein the existing object data records are linked to a process step data record, which is assigned to the respective process step, via a process input data record and the newly created object data records and object relation data records are linked to the process step data record via a process output data record.

By assigning the process data to unique existing object data records or object data records with value to be newly created using their detected value and using their reference content, a character set of possible detectable values is formed from the object data records with value, while the path resulting from the object data records with and without value as nodes and the object relation data records, which link the object data records with each other, as edges represents on the one hand the direct reference content of these values and on the other hand semantic units of higher value with respect to the information content. This means, for example, that a sequence of numbers is assigned to an object data record with content as a value, while the fact that this sequence of numbers is a serial number results from the linking of this object data record with value to an object data record without value, which corresponds to the serial number. The object data record without value thus describes not only the type of the sequence of numbers in this example, but the concrete serial number as such, which has this sequence of numbers. When a new process datum is acquired, the object data records without value can only be identified using the path representing the reference content of the values, so that in the case of a single detected value it is ensured that also the object data records without value within the data memory are unique. If several values are detected simultaneously, then under the assumption that all values refer to the same reference content, unique object data records can be achieved by aligning the individual paths to each other and projecting them onto each other. The common reference content of the individual values is then represented by those object data records that are common to all individual paths. For example, a serial number may consist not only of a sequence of numbers, but also of a product identifier, which in turn is a sequence of letters. In this case, two individual paths result for the assignment to the corresponding serial number, namely the path extending from the sequence of numbers and the path extending from the sequence of letters which share the data object without content, which corresponds to the serial number. If, according to the invention, the existing object data records are linked to a process step data record, which is assigned to the respective process step, via a process input data record, and the newly created object data records as well as object relation data records are linked to a process step data record, which is assigned to the respective process step, via a process output data record, a coherent mapping of the recorded process results due to the uniqueness of the object data records as long as at least one matching object data record or object relation data record is acquired in two successive process steps. This is always the case when process data of one process step are further processed in a subsequent process step. Due to the features according to the invention, this results in a static semantic model of the accumulating process data, which consists of object data records linked by object relation data records, on the one hand and a dynamic model of the actually running processes on the other hand, which is formed by object data records, which are linked via process output data records to the process step data records of those process steps in which the associated process data first occurred, and which are linked via process input data records to process step data records of those process steps in which these process data are further processed. Both models can be output separately and used to control and regulate the process sequences. To ensure data integrity, however, the two models are interlinked via the object data records and object relation data records, which, together with the uniqueness of the object data records, enables reliable determination of process sequences.

In order to be able to assign process data particularly quickly to unique existing object data records with and without content, it is proposed that the variable value and the reference content of a process datum are acquired together with process step information, after which the reference content is converted into a data path pattern for object data records and object relation data records based on an object data record with the value, and that object data records and/or object relation data records, which correspond to data path pattern sections, are first retrieved from a data memory using the data path pattern and linked via process input data records to the process step data record that corresponds to the process step information, whereupon object data records and/or object relation data records are newly created for missing data path pattern sections and linked via process output data records to the process step data record. This method has the advantage that, on the one hand, already higher semantic units can be linked to the respective process step data records via process input data records without the object data records, some of which are with content, that are required to generate the data path pattern also having to be linked to the process step data records in order to map a complete process. On the other hand, this ensures that already existing data objects are further used and are not created twice.

In order to prevent subsequent manipulation of the recorded process data, it is proposed that the object data records and/or object relation data records are provided with a write protection and/or a check value after completion of the process step creating them, except for a validity data field. The subsequent change of the validity of an object data record or an object relation data record is necessary due to the uniqueness of the object data records in case object data records become invalid or valid in successive process steps. However, considering that object data records form a character set of possible detectable values with their reference content as described above, it will be necessary to set object data records valid or invalid only in exceptional cases. Rather, the object relation data records that link the individual object data records to higher semantic units will be set valid or invalid. In addition or as an alternative to a write protection, a check value can be provided to make manipulations even more difficult, wherein the check values of individual object data records and object relation data records are based on each other in the sense of a block hash procedure. The check values can be based either on check values created earlier and/or on check values created for linked object data sets or object relation data sets. In addition, in a preferred embodiment, the process step data records and the associated process input data records and process output data records can also be provided with complete write protection after completion of the associated process step and, if necessary, also protected against manipulation with a check value in the sense of a block hash procedure.

In order to obtain statements about regularly running processes from individual process sequences, according to the invention each object data record, object relation data record, process step data record, process input data record and process output data record can be assigned to a type data record, wherein the object type data records and object relation type data records, which are linked to process step type data records via process input type data records and process output type data records, form a model describing the running processes. Among other things, this is advantageous in that dynamic models of possible process sequences and semantic models of possible object data records can be queried quickly. A quick query is made possible simply by the fact that, in the case of process sequences that recur at least from time to time, the type data records have a significantly smaller number than the process data so that the model memory can be queried correspondingly quickly. The assignment to a type data record can be made, for example, via a type data field in the object data records, object relation data records, process step data records, process input data records and process output data records. In this case, this field can also be excluded from a write protection and/or a check value to allow subsequent refinement of the model. For example, by using methods for grouping similar patterns known to those skilled in the art, new object types and object relation types can be derived from a group of object data records and object relation data records, for which new object type data records and object relation type data records are iteratively generated and linked.

These measures can also increase the processing speed, which is especially critical for real-time applications, by first converting the reference content into a model path pattern for object type data records and object relation type data records based on an object type data record of the object data record with the value, whereupon existing model paths or model path sections are retrieved from a model memory and data path patterns for querying the data memory are generated using these model paths or model path sections. An increase in speed results according to these features as mentioned above because the number of object data records and object relation data records present in the data memory is much higher than the number of object type data records and object relation type data records stored in the model memory, so that the required query time for model paths from object type data records and object relation type data records is substantially lower than for data paths from object data records and object relation data records. However, since each object data record and object relation data record is assigned to exactly one object type data record or object relation type data record, the query in the data memory can be performed much faster when the model path is known from the model memory. Another significant advantage is that the reference content does not have to be completely known, but can be supplemented by information from the model memory without delays. The reference content has to be complete only for object type data records or object relation type data records that do not yet exist. For example, with a sequence of numbers as value it would be sufficient to indicate a component as reference content without the object type of a serial number in the model memory as well as its object type relation to the object type of the sequence of numbers and its object type relation to the object type of the component having to be known and indicated. It is thus shown that, according to the features of the invention, the integrity of the recorded process data can be preserved despite incompletely specified reference contents.

In addition, in order to be able to make predictions about possible next process steps or about possible linked process data using a previous process sequence or using individual process data, it is suggested that for each process input type data record and process output type data record probability values that object data records of the associated object type data record are linked in a predetermined number to a process step data record of the associated process step type data record and probability values that process step data records of the associated process step type data record are linked in a predetermined number to an object data record of the associated object type data record be calculated and assigned to the process input type data record and process output type data record. Based on a predetermined object data record, the associated object type data record can be determined according to these measures, whereupon those process step type data records can be determined via the process input type data records and process output type data records which are sorted according to the associated probability values and are linked to the determined object type data record that represent those process steps in which the type of the predetermined object data record occurs with a predetermined probability and in a predetermined number. Conversely, this method can also be used to determine the probability of an object data record occurring in a predetermined number in a process step associated with a process step data record.

It is thus proposed that for each object data record, which is assigned to a process datum within a process step, first the associated object type data record and then those process input type data records and/or process output type data records are determined which link the object type data record to the process step type data record, which is associated with the process step data record of the process step, whereupon a warning signal is output or the monitored process is interrupted if the probability values assigned to the process input type data records and/or process output type data records are outside a predetermined value range.

In order to alternatively or additionally be able to monitor the integrity of the static semantic model of the object data records, it is proposed that for each object relation type data record that links a first object type data record to a second object type data record, probability values that object data records of the first object type data record are linked to object data records of the second object type data record in a predetermined number and probability values that object data records of the second object type data record are linked to object data records of the first object type data record in a predetermined number be calculated and assigned to the object relation type data record. These probability values can be used to check whether the linking of two data objects via a data object relation of a particular data object relation type is within or outside ordinary process parameters, and this can also be done across several process steps. For example, if an object data set can occur for the first time in either a first or a second process step, but can be subordinated to another object data set only once in total, the features according to the invention enable a reliable integrity check for this case as well.

The reference content of the values of individual process data can, for example, be fixedly predetermined using the position and the physical unit of a sensor. However, the values of the process data can also be detected via input fields of an input terminal, which are assigned to the reference content. This is advantageous in that even complex reference contents can be detected in a simple manner because, for example, entire operating sequences of the user at the input terminal, such as navigation through individual menu items, can be used as reference contents. In this context, the user can also be supported in a correct operation by determining, after the acquisition of individual process data using the probabilities assigned to the process input type data records and the process output type data records and/or using the probabilities assigned to the object relation type data records, object type data records for possible object data records, which, in the current process step and in view of the data objects assigned to the process data already acquired, can be linked to them or to the associated process step data record with a predetermined probability, and by displaying input fields for the acquisition of object data records with content of these types at the input terminal for the determined object type data records. In addition, the user may receive warnings for acquired process data for which the probability of occurrence of the associated object data records is outside a predetermined threshold range.

The invention also relates to a device for carrying out the method with a graph-based data memory for object data records and process step data records as nodes, for process input data records and process output data records as edges, and for object relation data records as nodes and edges, and with a graph-based model memory for object type data records and process step type data records as nodes, for process input type data records and process output type data records as edges, and for object relation type data records as nodes and edges, wherein data memory and model memory are each connected to a path query unit, which is controlled by an acquisition device, and to a path generation unit.

In a first step, the acquisition device receives process data, which have a variable value and a constant reference content, as well as process step information from external systems such as input terminals, wherein the reference content is converted into a data path pattern for object relation data records and object data records based on an object data record with content, which comprises the value, and is transferred to the path generation unit. In a next step, the data memory is checked for already existing data paths of the data path pattern by means of the path query unit. If this check is successful, the object data record corresponding to the data path pattern is linked to a process step data record, which is assigned to the process step information, via a newly created process input data record. If this check fails, the check is repeated based on the object data record with content with a data path pattern section extended by an object data record description in each case until the check fails. Then, based on the object data record that corresponds to the last successful check, object data records and object relation data records that correspond to the data path pattern section are newly created by means of the path generation unit and linked via process output data records to a process step data record, which is assigned to the process step information. If the process step data record does not yet exist, it can be newly created as part of the check.

In case a type data record is assigned to each object data record and object relation data record, the path pattern can also be built as a model path pattern from object type data records and object relation type data records. In this case, the query speed can be increased when the path query unit first checks the model memory for existing model path patterns and, in a second step, forms a data path pattern for querying the data memory from the model paths found.

Since the number of data records in the model memory is significantly lower than in the data memory, the data memory can not only be checked more quickly using the type information from the model memory despite the additional check of the model memory, but can also be checked without any loss of speed in the event that the model path pattern is not completely available.

### BRIEF DESCRIPTION OF THE INVENTION

In the drawings, the subject-matter of the invention is shown as an example. Wherein

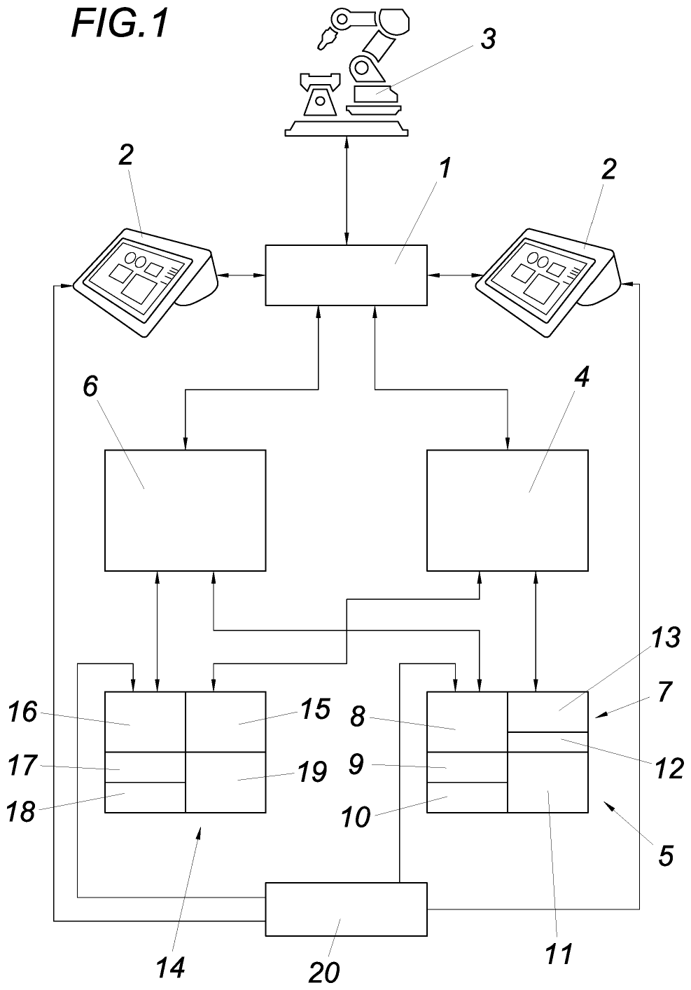

FIG. 1 is a block diagram of a device for carrying out the method according to the invention,

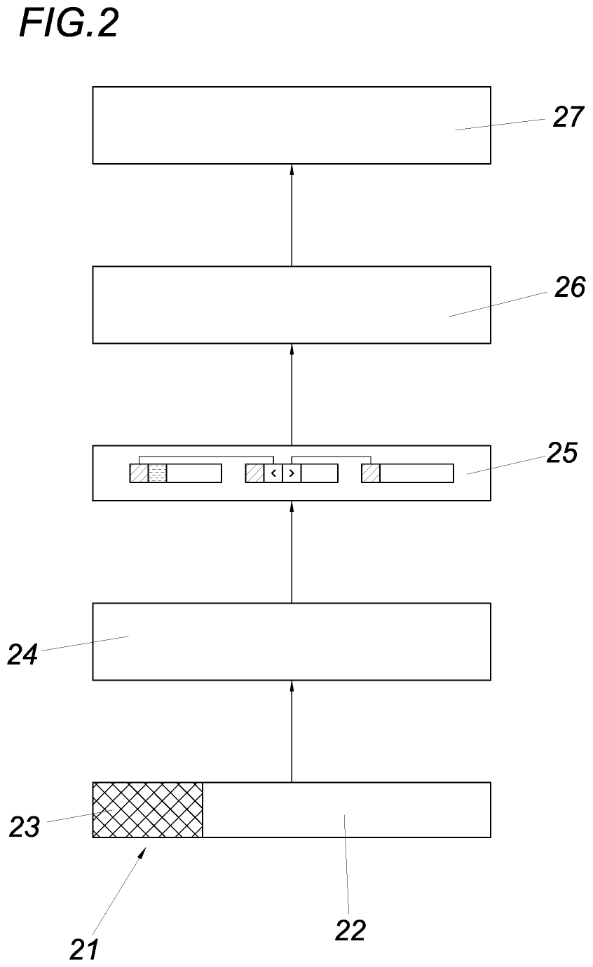

FIG. 2 is a flowchart for the acquisition of process data according to this method,

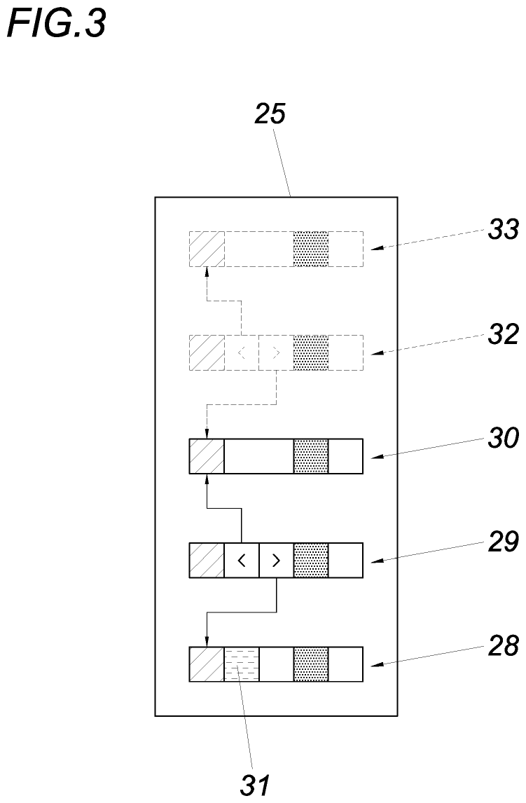

FIG. 3 is a schematic diagram of a data path pattern,

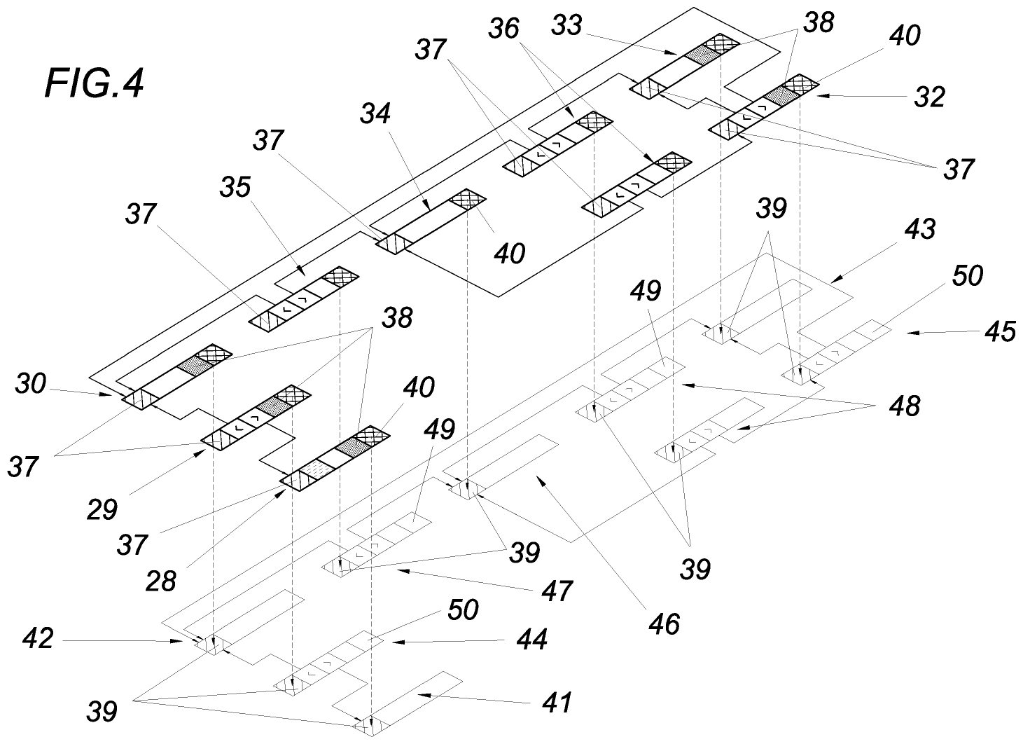

FIG. 4 is a schematic diagram of the data records generated by the method according to the invention, and

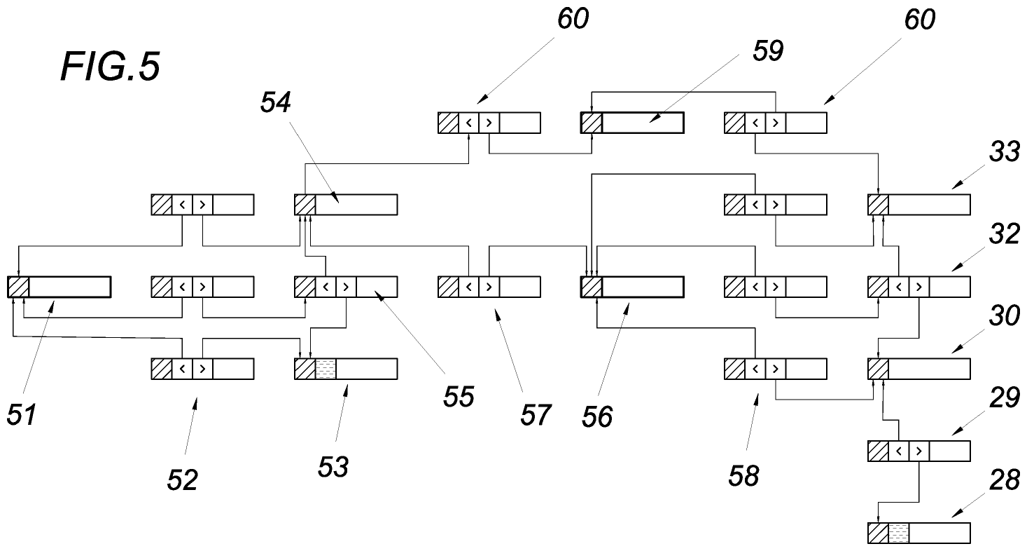

FIG. 5 is an example of the content of the data memory after a sequence of several process steps.

### WAYS OF CARRYING OUT THE INVENTION

A device for carrying out the method according to the invention comprises an acquisition device 1, which is connected, for example, to input terminals 2 and processing installations 3 via data lines. Individual, successive process steps of a processing process are assigned to these input terminals 2 and processing installations 3. To determine process sequences, process data are recorded via the acquisition device 1 and written into a data memory 5 via a path generation unit 4. To query the data memory 5, a path query unit 6 is provided, which is also connected to the acquisition device 1.

Preferably, the data memory 5 is graph-based and comprises an object data record memory area 7, a process step data record memory area 8, a process input data record memory area 9, a process output data record memory area 10, and an object relation data record memory area 11. In this context, “graph-based” means that the object data records and the process step data records are nodes, while the process input data records, process output data records and object relation data records form edges of a graph, which is preferably directed. The object data record memory 7 may preferably be divided into a memory area 12 for object data records with content and a memory area 13 for object data records without content.

In addition to the data memory 5, a model memory 14 may also be provided in a preferred embodiment, which is also accessed via the path query unit 6 and the path generation unit 4. This model memory 14 comprises an object type data record memory area 15, a process step type data record memory area 16 as well as a process input type data record memory area 17, a process output type data record memory area 18 and an object relation type data record memory area 19. This model memory 14 is also graph-based, with the object type data records and process step type data records forming nodes, while the process input type data records, process output type data records and object relation type data records form edges of a graph, which is also preferably directed.

In the data memory 5 as well as in the model memory 14, the object relation data records and the object relation type data records have a double function as nodes and edges in the graph.

To check and predict possible process data, an evaluation unit 20 may additionally be provided, which accesses both memories 5, 14 either via the path query unit 6 or, as illustrated in FIG. 1, directly.

FIG. 2 schematically illustrates the process of acquiring newly incoming process data with a device according to the invention. An incoming process datum 21 has a variable value 22 and a constant reference content 23. A constant reference content 23 may, for example, be the position of an impressed serial number along a first reference direction in mm. For example, the value 22 of such a reference content 23 could be “14”. According to this embodiment of the invention, in a first step 24 the reference content 23 is converted by the acquisition unit 1, based on the value 22, into a data path pattern 25 for object data records and object relation data records, which is shown in FIG. 3. Based on this data path pattern 25, object data records and/or object relation data records, which correspond to data path pattern sections, are first queried from the data memory 5 in a step 26, whereupon object data records and/or object relation data records are newly created for missing data path pattern sections in a step 27. The already existing object data records and/or object relation data records are thereby linked via process input data records to a process step data record, which corresponds to the associated process step, while the newly created object data records and/or object relation data records are linked to this process step data record via process output data records.

With reference to the data path pattern 25 shown in FIG. 3, this method will now be explained in more detail. This data path pattern 25 may, for example, represent the example of a process datum 21 referred to above, wherein the variable value 22 is assigned to an object data record with value 28, which is linked to an object data record without value 30 via an object relation data record 29. This object data record without value 30 represents the higher-order semantic unit “14 mm”. The object data record with value 28 has a value data field 31 in which the value “14” is stored. In order to completely map the reference content of the process datum 21, the object data record 30 is linked in the data path pattern 25 via a further object relation data record 32 to the object data record without value 33, which represents the higher-value semantic unit “14 mm as the position of an impressed serial number along a first reference direction”. As indicated by dashed lines in FIG. 3, for example, only the object data records 28 and 30 and the object relation data record 29 exist prior to the conduct of the described method. This means that apparently “14 mm” has already occurred in other reference contents as process datum. In order to assign or newly create object data records using the data path pattern 25, the data memory 5 can first be checked for already existing data paths of the entire data path pattern 25 by means of the path query unit 6. In the present example, this check fails because the object data record 33 and the object relation data record 32 do not yet exist in the data memory 5. Therefore, based on the object data record with value 28 with the data path pattern section extended by one object data record description each, the check is repeated until the check fails. In the present example, therefore, the object data record with value 28 is first successfully queried. Then, the object data record 28 is supplemented by the object data set description for the object data record 30, wherein the associated check also returns positive for the object data record 30. The data path pattern section extended by the object data record description for the object data record 33, which incidentally corresponds to the entire data path 25, can then no longer be successfully queried. The object data record 33 is therefore newly created and linked to the last successfully queried object data record 30 via a newly created object relation data record 32.

However, the data path pattern 25 may contain descriptions not only of object data records, but also of object relation data records, which can then be used to create new object relation data records.

According to the invention, however, object data records and object relation data records are not only created, but also linked to the process step data records, which correspond to the process steps running in each case, which can be seen in detail in particular in FIG. 4. The starting point here is again the example explained in FIGS. 2 and 3, wherein the process datum 21 of FIG. 2 is acquired for the first time and assigned to existing object data records or to object data records to be newly created in a process step in accordance with the method described above. To this end, process step information not shown in more detail in FIG. 2 is converted by the acquisition unit 1 into a data path pattern, which comprises a process step data record description. The pattern is passed to the path generation unit 4, which generates a corresponding process step data record 34 in the data memory 5, if this does not already exist. If the method described above is then carried out, the already existing object data record 30 is linked to this process step data record 34 via a process input data record 35 and the newly created object data record 33 as well as the newly created object relation data record 32 are linked to this process step data record 34 via process output data records 36. This results in the data memory 5 in the data record structure shown in FIG. 4. The linking of the individual data records results from the fact that each data record is provided with a unique identifier 37, wherein the relation data records 29, 32, 35, 36 each have one data field for the identifier 37 of the source data record and one data field for the identifier 37 of the target data record.

Due to the fact that the object data records are unique within the data memory 5 according to the described method, they can be provided with a validity data field 38. Object data records 28, 30, 33 can thus be valid or invalid at predetermined time intervals in the same way as object relation data records 29, 32, wherein the validity data field 38 is preferably designed in such a way that validity values can be assigned to specific time ranges.

In order to effectively prevent subsequent manipulation of the object data records 28, 30, 33 or the object relation data records 29, 32, it is proposed that they be provided with a check value which is not shown in more detail and which can be formed, for example, from a checksum of the data fields of the data records. In a preferred embodiment, the checksums of previously created object data records or object relation data records are also included in this checksum, resulting in a type of block hash that represents a particularly effective manipulation protection.

In order to obtain information about regularly running processes from individual process sequences and also to increase the query speed, especially for real-time-critical applications, it is proposed that a type data record be assigned to each of the described data records. These type data records are stored in the model memory 14 and are provided with a type identifier 39, the assignment being established via a type data field 40 in the data records of the data memory 5. Continuing the above example, the object type data record 41 “Number” is thus assigned to the object data record 28 with content “14”, the object type data record 42 “Length specification” is assigned to the object data record 30 without content “14 mm”, and the object type data record 43 “Position of an impressed serial number along a first reference direction” is assigned to the object data record 33 “14 mm as position of an impressed serial number along a first reference direction”, which is also without content. Similarly, object relation type data records 44, 45 are also assigned to the object relation data records 29, 32.

Further, after a process step type data record 46 is assigned to the process step data record 34, which process step type data record is linked to the object type data record 42 via a process input type data record 47 and to the object type data record 43 and the object relation type data record 45 via process output type data records 48, a model describing the running process results in the model memory 14, the components of which model are independent of concrete process data in the individual case. Thus, for example, the path query unit 6 can be used to query whether object data records 28, 30, 33 of a particular object data record type 41, 42, 43 are assigned or newly created within a process step and how these object data records 28, 30, 33 are linked to each other via object relation data records 29, 32. In this context, it is advantageous if probability values that object data records 28, 30, 33 of the associated object type data record 41, 42, 43 are linked in a predetermined number to a process step data record 34 of the associated process step type data record 46 and probability values that process step data records 34 of the associated process step type data record 46 are linked in a predetermined number to an object data record 28, 30, 33 of the associated object type data record 41, 42, 43 are assigned in particular to the process input type data record 47 and process output type data record 48 in transition probability data fields 49. Based on an object data record 28, 30, 33, it is thus possible to easily query via the evaluation unit 20, via the associated object type data record 41, 42, 43, which process steps of which type are based on these object data records 28, 30, 33 or generate them.

Likewise, the object relation type data records 44, 45 can also be provided with transition probability data fields 50, which can then be used to query the probability that certain object data record types are linked to each other in the context of a common reference content.

On this basis, the running processes can be continuously monitored via the evaluation unit 20 and warning signals can be output or the running processes can be interrupted if process data 21 occur whose assignment to object data records 28, 30, 33 and object relation data records 29, 32 as part of a process step data record 34 would exceed a predetermined probability threshold range.

Furthermore, the evaluation unit 20 can be directly connected to the input terminals 2 in order not only to be able to output warning signals, but also, as described above, to display input fields at the input terminals 2 for additional process data which are highly likely to occur, depending on the process data 21 already acquired in a process step.

The model memory 14 is also advantageous in that the reference content of process data 21 can be more easily specified in the abstract using object type data records and object relation type data records. For example, in the above example for the value “14”, it can be specified that this is a number (object type data record 41) representing a length specification (object type data record 42) and further representing the position of an impressed serial number along a first reference direction (object type data record 43). Based on this indication, a model path pattern can first be generated with the aid of which the model memory 14 is first queried, whereupon the obtained model paths and/or model path sections can be converted by the acquisition device 1 into data path patterns for querying the data memory 5 in the manner described above. Apart from the fact that the query of the model paths can be performed much faster due to the smaller amount of data in the model memory 14, this method also allows incomplete indications of the reference content. For example, the indication that the value “14” is a number (object type data record 41) indicating the position of an impressed serial number along a first reference direction (object type data record 43) can be supplemented via the model memory 14 by the object type data record 42, which takes into account the information that this position indication is usually a length indication in mm. Such a completion is admittedly only possible if the type data records for the specified reference content are already completely available.

It turns out that with the method and device according to the invention, data integrity can thus be maintained for recorded process data even in the case of incomplete process data.

The formation of a complete process sequence with the method according to the invention can finally be explained with reference to FIG. 5, wherein in a first process step a serial number is acquired via a terminal 2. A process step data record 51 is assigned to this process step, which process step data record is linked via process output data records 52 to an object data record with value 53, which corresponds to the sequence of numbers of the serial number, and to the object data record without value 54, which represents the serial number itself. As part of this process step, the object data record 53 is also linked to the object data record 54 via an object relation data record 55. Then, the serial number is transferred to a processing installation 3, which impresses the serial number on a workpiece. Thereby, the serial number as well as the position of the impression are transmitted to the acquisition device 1 and processed in accordance with the method according to the invention. The process step was therefore assigned to a process step data record 56, which was linked to the object data record 54 of the serial number via a process input data record 57. This process step data record 56 is linked via process step output data records 58 to the newly created object data record 33 “14 mm as the position of an impressed serial number along a first reference direction” as well as to the object data record 30 “14 mm” newly created as part of the process step. Via the object data record 54, which corresponds to the serial number, the process step data records 51 and 56 are thus already linked to form a process section. In the illustration of FIG. 5, the impression of the serial number according to the process step data record 56 is followed by a final quality check via one of the input terminals 2. The process step data record 59 is assigned to this process step of the quality check. In this process step, the user checks the serial number, which corresponds to the object data record 54, on the one hand and the position of the impression of this serial number, which corresponds to the object data record 33, on the other hand. Accordingly, both the object data record 54 and the object data record 33 are linked to the process step data record 59 via process input data records 60. Overall, this results in a data record pattern that corresponds to the process sequence for which, in a preferred embodiment, corresponding type data records are created, which have been omitted from FIG. 5 for clarity.

1. A method for determining process sequences from individual process data that occur repeatedly in successive process steps, and each have a respective variable value and a respective constant reference content, said method comprising:
assigning, for successive process steps, the process data thereof to a unique existing object data record with value or an object data record with value that is newly created using the variable value and using the reference content;
linking the object data records with value via object relation data records according to reference content thereof to object data records without value;
linking the existing object data records to a process step data record that is assigned to the respective process step via a process input data record; and
linking the newly created object data records and object relation data records to the process step data record via a process output data record.

2. The method according to claim 1, and further comprising
acquiring the variable value and the reference content of a process datum of the process data together with process step information, and then converting the reference content into a data path pattern for object data records and object relation data records based on an object data record with the value, and
first retrieving the object data records and/or object relation data records, which correspond to path pattern sections, from a data memory using the data path pattern and linking them via process input data records to the process step data record, which corresponds to the process step information, and then newly creating object data records and/or object relation data records for missing data path pattern sections and linking them to the process step data record via process output data records.

3. The method according to claim 1, and further comprising
providing the object data records and/or object relation data records with a write protection and/or a check value after completion of the process step creating them, except for a validity data field.

4. The method according to claim 1, and further comprising
assigning each object data record, object relation data record, process step data record, process input data record and process output data record to a type data record, and wherein the object type data records and object relation type data records, which are linked to process step type data records via process input type data records and process output type data records, form a model describing the running processes.

5. The method according to claim 4, and further comprising
first converting, based on an object type data record of the object data record with the value, the reference content into a model path pattern for object type data records and object relation type data records, and then after
retrieving existing model paths or model path sections from a model memory and
generating data path patterns for querying the data memory using said model paths or model path sections.

6. The method according to claim 4, and further comprising,
for each process input type data record and process output type data record, calculating probability values that object data records of the associated object type data record are linked in a predetermined number to a process step data record of the associated process step type data record, and probability values that process step data records of the associated process step type data record are linked in a predetermined number to an object data record of the associated object type data record and
assigning said probability values to the process input type data record and process output type data record.

7. The method according to claim 6, and further comprising, for each object data record assigned to a process datum within a process step, first determining the associated object type data record and then determining said process input type data records and/or process output type data records that link the object type data record to the process step type data record associated with the process step data record of the process step, after which a warning signal is output or the monitored process is interrupted responsive to a determination that the probability values associated with the process input type data records and/or process output type data records are outside a predetermined value range.

8. The method according to claim 4, and further comprising
calculating, for each object relation type data record linking a first object type data record to a second object type data record, probability values that object data records of the first object type data record are linked to object data records of the second object type data record in a predetermined number and probability values that object data records of the second object type data record are linked to object data records of the first object type data record in a predetermined number and assigning said probability values to the object relation type data record.

9. The method according to claim 8, and further comprising
assigning the values of the process data via input fields of an input terminal, which are assigned to the reference content,
determining, after the acquisition of individual process data, object type data records for possible object data records using the probability values assigned to the process input type data records and the process output type data records and/or the probability values assigned to the object relation type data records, said object type data records, in the current process step and in view of the data objects assigned to the already recorded process data, being configured to be linked thereto or to the associated process step data record with a predetermined probability, and
wherein input fields are displayed on the input terminal for the determined object type data records.

10. A device for carrying out the method according to claim 1, said device comprising:
a graph-based data memory storing object data records and process step data records as nodes, storing process input data records and process output data records as edges, and storing object relation data records as nodes and edges, and
a graph-based model memory storing object type data records and process step type data records as nodes, storing process input type data records and process output type data records as edges, and storing object relation type data records as nodes and edges,
wherein said data memory and said model memory are each connected to a path enquiry unit that is controlled by an acquisition device, and to a path generation unit.
